(19) United States
(12) Patent Application Publication
(10) Pub. No.: US 2003/0232005 A1
(43) Pub. Date: Dec. 18, 2003

(54) Manufacturing method of phosphor precursor

(76) Inventors: Hisatake Okada, Tokyo (JP); Satoshi Ito, Tokyo (JP); Takayuki Suzuki, Tokyo (JP); Hideki Hoshino, Tokyo (JP); Naoko Furusawa, Tokyo (JP)

Correspondence Address: Squire, Sanders & Dempsey L.L.P., Suite 300, One Maritime Plaza, San Francisco, CA, 94111, US

(21) Appl. No.: 10/460,809

(22) Filed: Jun. 11, 2003

(30) Foreign Application Priority Data
Jun. 18, 2002 (JP) JP2002-176841

(51) Int. Cl. C01G 57/00

(52) U.S. Cl. 423/659; 423/277

(57) ABSTRACT

A method for manufacturing a phosphor precursor by using a mixing device comprising:

(a) at least one first inlet flow passage;

(b) at least one second inlet flow passage, the first and the second inlet flow passages connect together so as to form a collision section; and

(c) an outlet flow passage which is connected with the collision section,

the method comprising the steps of:

(i) supplying continuously a first and a second raw phosphor materials into the inlet flow passages;

(ii) introducing the first and the second raw phosphor material solutions into the collision section so as to form a phosphor precursor; and

(iii) releasing continuously the phosphor precursor from an exit of the outlet flow passage with controlling a Reynolds number of the phosphor precursor to be not less than 3000 while retaining the phosphor precursor in the outlet flow passage for not less than 0.001 seconds.

### TECHNICAL FIELD

The present invention relates to a manufacturing method of a phosphor precursor.

### BACKGROUND

In recent years, in accordance with progress of an information oriented society, various color cathode ray tubes such as a flat panel display (hereinafter, also referred to as a FPD) and a color Braun tube have come to be provided with a larger image plane and a higher contrast and to be required to form further finer image pixels on a face plate to form a high definition image plane. Therefore, improvement of various characteristics such as increase of emission luminance and increase of adhesive strength are required of a phosphor.

Heretofore, particles having a particle diameter of approximately from 2 to 7 μm which were developed for a color cathode ray tube have been utilized as a phosphor for a flat panel display, and improvement of various characteristics has been required since little progress has been achieved in development of optimized substances for each flat panel display in respect to such as an excitation wavelength. Particularly, a phosphor of a small particle diameter as well as of monodisperse, and having a high luminance has been required along with increasing definition of a display in future.

As a general manufacturing method of an inorganic phosphor (hereinafter, also referred to simply as a phosphor), there are a solid phase method in which an inter-solid reaction is performed by burning after mixing prescribed amounts of a compound containing an element constituting a mother substance of a phosphor and of a compound containing an activating element, and a liquid phase method in which burning is performed after solid-liquid separation of a phosphor precursor precipitation obtained by mixing a solution of a raw material of a phosphor containing an element constituting a mother substance of a phosphor and a solution containing an activating element together.

It is necessary to bring a phosphor composition as close as possible to a stoichiometric composition to increase an emission efficiency and a yield of a phosphor, however, it is difficult to manufacture a phosphor having a purely stoichiometric composition by a solid phase method. Because a solid phase method is an inter-solid reaction, excess impurities which do not react or complex salts produced by a reaction may often remain, resulting in that a phosphor having a stoichiometrically high purity is hard to be obtained.

Further, a phosphor obtained by a solid phase method is provided with a relatively wide particle size distribution, and a phosphor having a large particle diameter as well as a wide particle size distribution close to a normal distribution is obtained particularly when burning is performed by incorporating a large amount of flux. When a phosphor film is formed by use of such a phosphor, it is not preferable, in order to prepare a phosphor film having a high luminance and minuteness, that many fine particles and big particles are present. These fine particles and big particles may be eliminated by a classification operation when necessary, however, a classification operation is poor in a working property and lowers the yield; particularly generation of big particles significantly affects the yield of particles of a desired particle size, in addition, it is not necessarily possible to secure the elimination. Therefore, in case of forming a phosphor film for a high definition FPD, it comes to be important not to generate unnecessary fine particles and big particles, particularly big particles, at the time of burning.

Further, since a phosphor obtained by a solid phase method shows decrease of emission efficiency and emission luminance as the particle size decreases, it is actual that a phosphor of not more than 1 μm having sufficient emission efficiency and sufficient emission luminance has been hardly supplied. There are some disclosures with respect to a manufacturing method of a phosphor having a particle diameter of not more than 1 μm, however, particles of not more than 1 μm are obtained by a classification operation such as disclosed in JP-A No. 8-81678 (hereinafter, JP-A refers to Japanese Patent Publication Open to Public Inspection) resulting in problems of decreased luminance and lowered yield of a phosphor due to a classification operation.

Further, in each process of manufacturing of a phosphor, aggregation has made the particle size big and has been an obstacle to make the particle size finer, and there are few inventions in respect to preventing this; there is only an description on a sintering inhibitor in JP-A No. 6-306358, however, the effect cannot be said sufficient.

On the other hand, in case of manufacturing a phosphor by a liquid phase method, firstly, after a precipitate, which is a precursor of a phosphor, is formed, the precursor is burned to be a phosphor. In a liquid phase method, since a reaction is induced by an element ion constituting a phosphor, a phosphor having stoichiometrically high purity is easily obtained, however various characteristics such as a particle diameter, a particle shape, a particle diameter distribution and emission characteristics largely depend on properties of a precursor. For that reason, consideration on controlling a particle shape and a particle diameter distribution and eliminating impurities, at the time of preparation of a phosphor precursor, is necessary to obtain a desired phosphor.

Therefore, many improvement methods, with respect to a manufacturing method of a phosphor by a liquid phase method, have been proposed. For example, there disclosed in JP-A No. 2001-172627 that with respect to a manufacturing method of a rare earth phosphate phosphor for a phosphor lamp, and a rare earth phosphate phosphor precursor is formed by adding a solution of raw materials for a phosphor in which an ion of rare earth element and a phosphate ion coexist into an aqueous solution controlled to a pH of from 1.0 to 2.0. Further, there disclosed in JP-A No. 9-71415 that with respect to a manufacturing method of a rear earth oxide, and a spherical rare earth oxide is formed by reacting a rare earth ion and an oxalate ion while the system is kept at from −5 to 20° C.

However, in these methods, although there is a merit in that a high purity composition and spherical particles can be obtained compared to a phosphor obtained by a solid phase method, it is still insufficient to obtain a phosphor having a small particle diameter and a high luminance.

Further, there are some proposals on improvement with respect to a manufacturing apparatus of a phosphor precursor by a liquid phase method. For example, techniques with respect to a precursor manufacturing apparatus for a stimulable phosphor are disclosed in JP-A Nos. 2001-26776, 2001-40349 and 2001-329260, however, in all of them nucleation and growth are performed in a single vessel to give insufficient results in respect to control of a particle diameter and a crystal habit of phosphor precursor particles due to a particle formation in such a state in a vessel as being changed every minutes, and a phosphor having a small particle diameter as well as a high luminance cannot be obtained, at present.

### SUMMARY

An object of the present invention, taking the above described problems in consideration, is to provide a manufacturing method of a phosphor precursor, in which a particle diameter and a crystal habit of phosphor precursor particles are controlled to obtain a phosphor having a small particle diameter as well as a high luminance.

The above object of the invention has been achieved by the following embodiments.

One structure of the present invention is a method for manufacturing a phosphor precursor by using a mixing device comprising:

(a) at least one first inlet flow passage;

(b) at least one second inlet flow passage, the first inlet flow passage and the second inlet flow passage connect together so as to form a collision section; and

(c) an outlet flow passage which is connected with the collision section,

the method comprising the steps of:

(i) supplying continuously a first raw phosphor material solution into the first inlet flow passage and a second raw phosphor material solution into the second inlet flow passage;

(ii) introducing the first raw phosphor material solution and the second raw phosphor material solution into the collision section so as to mix with each other and to form a phosphor precursor; and

(iii) releasing continuously the phosphor precursor from an exit of the outlet flow passage with controlling a flow of the phosphor precursor so as to keep a Reynolds value of the phosphor precursor to be not less than 3000 while retaining the phosphor precursor in the outlet flow passage for not less than 0.001 seconds.

Another structure of the present invention is a method for manufacturing a phosphor precursor by using a mixing device comprising:

(a) a first inlet flow passage;

(b) a second inlet flow passage, the first inlet flow passage and the second inlet flow passage connect together so as to form a collision section; and

(c) an outlet flow passage (or may be called a third flow passage) which is connected with the collision section, the method comprising the steps of:

(i) supplying continuously a first raw phosphor material solution into the first inlet flow passage and a second raw phosphor material solution into the second inlet flow passage;

(ii) introducing the first raw phosphor material solution and the second raw phosphor material solution into the collision section so as to mix with each other and to form a phosphor precursor; and

(iii) releasing continuously the phosphor precursor from an exit of the outlet flow passage, wherein in the step (iii), the flow rate of the phosphor precursor is larger than a flow rate of the first raw phosphor material solution and a flow rate of the second raw phosphor material solution.

### BRIEF DESCRIPTION OF THE DRAWINGS

FIG. 1 shows schematically, such as a main part (a flow passage is a Y-type) and a vessel for ripening/growth of particles, of a manufacturing apparatus according to the invention.

FIG. 2 shows schematically, such as a main part (a flow passage is a T-type) and a vessel for ripening/growth of particles, of a manufacturing apparatus according to the invention.

FIG. 3 shows another embodiment of a manufacturing apparatus according to the invention.

FIG. 4 is a conceptual drawing showing an example in which a flow passage form represents a T-type.

FIG. 5 is a conceptual drawing showing an example in which a flow passage form represents a Y-type.

### DESCRIPTION OF THE PREFERRED EMBODIMENTS

In what follows, a manufacturing apparatus of a phosphor precursor and a manufacturing method of a phosphor precursor according to the invention will be further detailed.

A phosphor precursor (hereinafter, also referred to simply as a precursor) is an intermediate product of a phosphor, and a phosphor can be obtained by burning the phosphor precursor at a prescribed temperature.

In the invention, a precursor, after being synthesizing by a liquid phase method, is preferably washed after being recovered by a method such as filtration, evaporation to dryness or centrifugal separation, and further may be subjected to several processes such as drying and burning, and may be classified.

In a manufacturing method of a phosphor precursor according to the invention, it is preferable to eliminate impurities such as complex salts from a precursor by being subjected to a desalting process prior to a burning process. Electric conductivity of a precursor after desalting of the precursor is preferably in a range of from 0.0001 to 20 mS/cm, further preferably from 0.01 to 10 mS/cm and specifically preferably from 0.01 to 5 mS/cm.

When it is less 0.0001 mS/cm, it is unsatisfactory to obtain the effect of the invention, and productivity is also poor. While, when it is over 20 mS/cm, particles may become big and a particle diameter distribution may be widened due to insufficient elimination of auxiliary salts or impurities, resulting in deterioration of emission strength.

In the invention, as a measurement method to determine the above-described electric conductivity, any measuring method can be utilized, and it can be measured by use of an electric conductivity tester available on the market.

As a desalting method preferably utilized in a desalting process of the invention, various kinds of film separation methods, an ultra filtration method, a coagulation method, an electodialysis method, a method utilizing an ion-exchange resin and a noodle washing method are preferably utilized.

Further, it is preferable to mix a protective colloid in not less than one of or all of solutions of a raw material for a phosphor (hereinafter, they may be referred to simply as solutions).

A protective colloid utilized in the invention functions to prevent coagulation of phosphor particles (hereinafter, they may be referred to simply as particles) each other, and the function is clearly different from that of an organic polymer utilized to control a crystal habit described in JP-A No. 2001-329262.

As a protective colloid preferably utilized in the invention, variety of polymer compounds no matter whether natural or synthetic can be used. In that case, a mean molecular weight of a protective colloid is preferably not less than 10,000, more preferably from 10,000 to 300,000 and specifically preferably from 10,000 to 30,000. Further, as a concrete protective colloid, protein is preferable and specifically gelatin is preferable. Further, it is not necessary a composition of a single component, but can be mixed with various kinds of binders.

In the invention, a drying method of a phosphor precursor is not specifically limited, and every method such as vacuum drying, pneumatic conveying drying, fluidized bed drying and spray drying is utilized.

In the invention, burning temperature and time of a phosphor precursor are not specifically limited, and can be suitably selected according to a kind of a phosphor. Further, a gas atmosphere at the time of burning may be any of an oxidizing atmosphere, a reducing atmosphere or an inert atmosphere, and can be suitably selected according to the purpose. A burning apparatus is neither limited specifically and every apparatus can be utilized. For example, such as a box-type furnace, a pot furnace and a rotary kiln are preferably utilized.

At the time of burning, a sintering inhibitor may be or may not be added. In case of adding a sintering inhibitor, it may be added as a slurry at the time of precursor formation, and further a method, in which a powdery precursor is mixed with a dried precursor to be subjected to burning, is preferably utilized. Further, a sintering inhibitor is not limited specifically and suitably selected according to a kind of a phosphor and burning conditions. For example, depending on a burning temperature of a phosphor, a metal oxide such as TiO₂ in burning at not higher than 800° C., SiO₂ in burning at not higher than 1000° C. and Al₂O₃ in burning at not higher than 1700° C. are preferably utilized respectively.

A phosphor obtained by burning a phosphor precursor prepared according to a manufacturing method of the invention can be subjected to surface treatment such as absorption and coating for various purposes. The timing when a surface treatment is provided depends on the purpose and is suitably selected to make the effect significant. For example, when the surface of a phosphor is coated with an oxide containing at least one element selected from Si, Ti, Al, Zr, Zn, In and Sn at any time before the dispersion process, it is possible to depress decrease of a crystallization property of a phosphor at the time of dispersion treatment and further to depress decrease of emission luminance and emission strength by preventing excited energy from being captured by a surface defect of a phosphor. Further, when a surface of a phosphor is coated by such as an organic polymer compound at any time after the dispersion process, characteristics such as weather-proofing are improved and an inorganic phosphor having excellent durability can be obtained. Such as a coating layer thickness or a covering ratio at the time of the surface treatment can be suitably arbitrarily adjusted.

A composition of inorganic phosphor particles of the invention is described, for example, in JP-A Nos. 50-6410, 61-65226, 64-22987, 64-60671 and 1-168911, and is not specifically limited, however, combinations of metal oxides represented by Y₂O₂S, Zn₂SiO₄, Ca₅(PO₄)₃Cl as a crystal matrix and sulfides represented by ZnS, SrS and CaS; with ions of rare earth metals such as Ce, Pr, Nd, Pm, Sm, Eu, Gd, Tb, Dy, Ho, Er, Tm and Yb, and ions of metals such as Ag, Al, Mn and Sb as an activator or a co-activator; are preferable.

Preferable examples of a crystal matrix include, for example, ZnS, Y₂O₂S, Y₃Al₅O₁₂, Y₂SiO₅, Zn₂SiO₄, Y₂O₃, BaMgAl₁₀O₁₇, BaAl₁₂O₁₉, (Ba,Sr,Mg)O.BaAl₂O₃, (Y,Gd)BO₃, Y₂O₃, (Zn,Cd) S, SrGa₂S₄, SrS, GaS, SnO₂, Ga₁₀(PO₄)₆(F,Cl)₂, (Ba,Sr)(Mg,Mn)Al₁₀O₁₇, (Sr,Ca,Ba,Mg)₁₀(PO₄)₆Cl₂, (La,Ce)PO₄, CeMgAl₁₁O₁₉, GdMgB₅O₁₀, Sr₂P₂O₇, Sr₄Al₁₄O₂₅, etc.

A crystal matrix and an activator or a co-activator are not specifically limited with respect to the element compositions, and those in which a part of elements is substituted by a homologue element can also be utilized; any combinations can be utilized provided that they emit visible light by absorbing excitation light in a ultraviolet region, however, it is preferable to utilize an inorganic oxide phosphor or an inorganic halide phosphor.

Concrete examples of an inorganic phosphor obtained from a phosphor precursor of the invention will be shown below, however, the invention is not limited thereto.

<Blue Light Emitting Inorganic Phosphor Compound>

| | |
|---|---|
| (BL-1) | Sr₂P₂O₇:Sn⁴⁺ |
| (BL-2) | Sr₄Al₁₄O₂₅:Eu²⁺ |
| (BL-3) | BaMgAl₁₀O₇₁:Eu²⁺ |
| (BL-4) | SrGa₂S₄:Ce³⁺ |
| (BL-5) | CaGa₂S₄:Ce³⁺ |
| (BL-6) | (Ba,Sr) (Mg,Mn) AL₁₀O₁₇:Eu²⁺ |
| (BL-7) | (Sr,Ca,Ba,Mg)₁₀(PO₄) ₆Cl₂Eu²⁺ |
| (BL-8) | ZnS:Ag |
| (BL-9) | CaWO₄ |
| (BL-10) | Y₂SiO₅:Ce |
| (BL-11) | ZnS:Ag,Ga,Cl |
| (BL-12) | Ca₂B₅O₉Cl:Eu²⁺ |
| (BL-13) | BaMgAl₁₄O₂₃:Eu²⁺ |
| (BL-14) | BaMgAl₁₀O₁₇:Eu²⁺,Tb³⁺,Sm²⁺ |
| (BL-15) | BaMgAl₁₄O₂₃:Sm²⁺ |
| (BL-16) | Ba₂Mg₂Al₁₂O₂₂:Eu²⁺ |
| (BL-17) | Ba₂Mg₄Al₁₈O₁₈:Eu²⁺ |
| (BL-18) | Ba₃Mg₅Al₁₈O₃₅:Eu²⁺ |
| (BL-19) | (Ba,Sr,Ca) (Mg,Zn,Mn) Al₁₀O₁₇:Eu²⁺ |

<Green Light Emitting Inorganic Phosphor Compound>

| | |
|---|---|
| (GL-1) | (Ba,Mg) Al₁₆O₂₇:Eu²⁺,Mn²⁺ |
| (GL-2) | Sr₄Al₁₄O₂₅:Eu²⁺ |
| (GL-3) | (Sr,Ba) Al₂Si₂O₈:Eu²⁺ |
| (GL-4) | (Ba,Mg) ₂SiO₄:Eu²⁺ |
| (GL-5) | Y₂SiO₅:Ce³⁺,Tb³⁺ |
| (GL-6) | Sr₂P₂O₇—Sr₂B₂O₅:Eu²⁺ |
| (GL-7) | (Ba,Ca,Mg)₅(PO₄) ₃Cl:Eu²⁺ |
| (GL-8) | Sr₂Si₃O₈—2SrCl₂:Eu²⁺ |
| (GL-9) | Zr₂SiO₄,MgAl₁₁O₁₉:Ce³⁺,Tb³⁺ |
| (GL-10) | Ba₂SiO₄:Eu²⁺ |
| (GL-11) | ZnS:Cu,Al |
| (GL-12) | (Zn,Cd)S:Cu,Al |
| (GL-13) | ZnS:Cu,Au,Al |
| (GL-14) | Zn₂SiO₄:Mn |
| (GL-15) | ZnS:Ag,Cu |
| (GL-16) | (Zn,Cd)S:Cu |
| (GL-17) | ZnS:Cu |
| (GL-18) | Gd₂O₂S:Tb |
| (GL-19) | La₂O₂S,Tb |
| (GL-20) | Y₂SiO₅:Ce,Tb |
| (GL-21) | Zn₂GeO₄:Mn |
| (GL-22) | CeMgAl₁₁O₁₉:Tb |
| (GL-23) | SrGa₂S₄:Eu²⁺ |
| (GL-24) | ZnS:Cu,Co |
| (GL-25) | MgO.nB₂O₃:Ce,Tb |
| (GL-26) | LaOBr:Tb,Tm |
| (GL-27) | La₂O₂S:Tb |
| (GL-28) | SrGa₂S₄:Eu²⁺,Tb³⁺,Sm²⁺ |

<Red Light Emitting Inorganic Phosphor Compound>

| | |
|---|---|
| (RL-1) | Y₂O₂S:Eu³⁺ |
| (RL-2) | (Ba,Mg) ₂SiO₄:Eu³⁺ |
| (RL-3) | Ca₂Y₈ (SiO₄) ₆O₂:Eu³⁺ |
| (RL-4) | LiY₉(SiO₄) ₆O₂:Eu³⁺ |
| (RL-5) | (Ba,Mg) Al₁₆O₂₇:Eu³⁺ |
| (RL-6) | (Ba,Ca,Mg)₅(PO₄) ₃Cl:Eu³⁺ |
| (RL-7) | YVO₄:Eu³⁺ |
| (RL-8) | YVO₄:Eu³⁺,Bi³⁺ |
| (RL-9) | CaS:Eu³⁺ |
| (RL-10) | Y₂O₃:Eu³⁺ |
| (RL-11) | 3.5MgO, 0.5MgF₂GeO₂:Mn |
| (RL-12) | YAlO₃:Eu³⁺ |
| (RL-13) | YBO₃:Eu³⁺ |
| (RL-14) | (Y,Gd) BO₃:Eu³⁺ |

The particle diameter of an inorganic phosphor obtained from a precursor of the invention is not specifically limited, however, a smaller mean particle diameter in advance is advantageous for the latter dispersion treatment. Concretely, a mean particle diameter is preferably not more than 1.0 μm and more preferably not more than 0.8 μm. Herein, a particle diameter of an inorganic phosphor means an equivalent sphere particle diameter. An equivalent sphere particle diameter is a particle diameter represented by the diameter of a supposed sphere which has the same volume as that of a particle.

Further, a particle diameter distribution is also advantageous when it is narrower because of the same reason as described above and, concretely, a coefficient of variation of particle diameter distribution is preferably not more than 100% and more preferably not more than 70%. Herein, a coefficient of variation of particle diameter distribution (width of a particle diameter distribution) is a value defined according to the following equation.

$$Width of particle diameter distribution ( coefficient of variation ) ( \% ) = ( standard deviation of particle size distribution / average of particle size ) \times 100$$

An inorganic phosphor dispersion obtained by a manufacturing method of an inorganic phosphor precursor according the invention can be applied to various purposes. For example, it can be applied to various methods such as being mixed with other liquid materials such as a solution or a solid dispersion to form a liquid phosphor material or being coated as it is or as a mixture containing the inorganic phosphor dispersion on a base material.

Utilizing purposes of a phosphor obtained from a precursor of the invention is not specifically limited, and include, for example, an inorganic phosphor layer of various kinds of image display devices such as a plasma display panel, a field emission display, an electro-luminescence device, an active emitting liquid crystal device and a cathode ray tube (CRT); ink for an ink jet printer, ink for a laser printer, and other various kinds of ink suitable for printing styles such as offset printing and a transfer ribbon; colorants utilized for electrophotographic toner or various kinds of paint and writing tools; in addition to various purposes such as a colorant for an electrophotographic recording medium, a silver halide photographic material, an intensifying screen, etc.

Particularly, in case of being applied in a variety of ink and a variety of colorants, an inorganic phosphor dispersion of the invention may be mixed in a solution or a solid dispersion containing colorants such as a dye or a pigment mainly for the purpose of such as color correction, and also may be applied as a phosphor material, without containing a colorant, of which a main component is an inorganic phosphor.

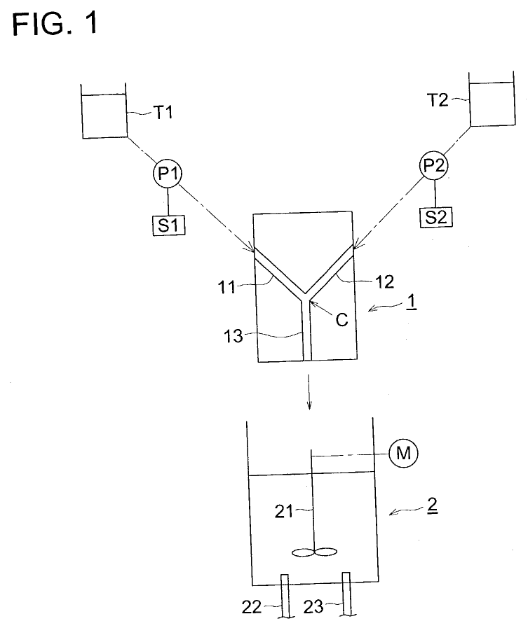

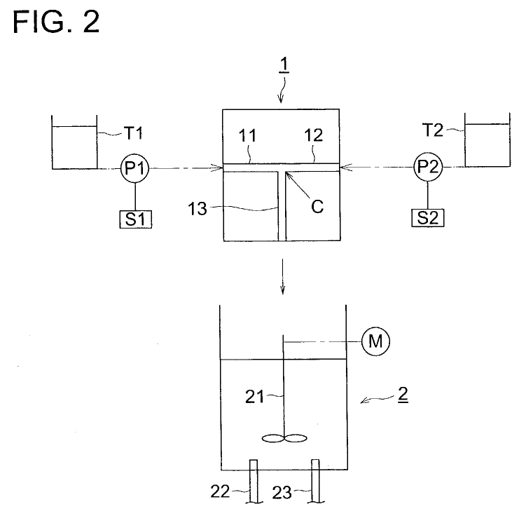

In what follows, an embodiment of the invention will be explained in reference to the drawings. FIGS. 1 and 2 illustrate schematically a main portion of a manufacturing apparatus to produce phosphor precursor particles and a vessel to perform ripening and growth of particles.

FIG. 1 and FIG. 2 differ from one another only in a form of the flow passage described below (Y type, T type), and means having the same functions are shown by the same number.

In the figures, 1 is a manufacturing apparatus and 2 is a vessel for ripening and growth. T1 and T2 each are tanks to store the above-described phosphor raw material solutions, respectively. Manufacturing apparatus 1 is provided with first flow passage 11 to incorporate a raw material solution of a phosphor in tank 1, second flow passage 12 to incorporate a raw material solution of a phosphor in tank 2, and third flow passage 13 described later (the cross section is circular). The above-described first, second and third flow passages have a diameter of 1 mm.

One ends of above-described first flow passage 11 and second flow passage 12 are arranged so that solutions continuously supplied in each flow passage collide to be mixed at crossing point C, and one end of third flow passage is connected to one ends of the above-described two flow passages at crossing point C so as to continuously receive a mixed solution after collision.

That is, a manufacturing apparatus of the invention has a constitution in which the above described one ends of three flow passages meet to form crossing point C. It is important to care a constitution so as to enable a solution after collision at crossing point C never to reverse flow and a liquid in a manufacturing apparatus (practically, in third flow passage 13) to be transported (liquid movement) at least until the time when particle nuclei immediately formed by collision and mixing are stabilized.

Herein, time required for particles to be stabilized is set not shorter than 0.001 sec., and third flow passage 13 is provided with a diameter and a length to satisfy this.

The raw material solution of a phosphor is controlled to be sent into each flow passage described above at a Reynolds number of not less than 3000 by pumps P1 and P2 which is operated under the control by control means S1 and S2. Flow rates of the above-described both solutions before mixing may be same or different.

The above-described third flow passage can provide a solution after mixing with a flow rate faster than that of each solution sent into the first and second flow passages. Above-described control means S1 and S2 may be united to one, and above-described pumps P1 and P2 are desirably non-pulsation pumps. Ripening/growth vessel 2 is provided with stirring fan 21. M is a motor, which is a rotation power source for above-described stirring fan 21. 22 is a nozzle for introducing a raw material solution of phosphor 3 into the above described vessel, and 23 is a nozzle for introducing raw material solution of a phosphor 4 so that a double jet method is possible to be performed. The above-described solutions may be added under the control of such as pH.

A working state based on the constitution as described above will be briefly explained.

In a state that prescribed solutions are stored in tanks T1 and T2, when pumps P1 and P2 start working under the control of control means S1 and S2, a raw material solution of a phosphor is sent into first flow passage 11 and another raw material solution of a phosphor is sent into second flow passage 12, in a state of a turbulent flow.

Very soon, the above-described both solutions reach crossing point C, and, after having collided thereat, go into third flow passage 13 in a mixed state. Nuclei of phosphor precursor particles are formed by collision and mixing of the above-described both solutions.

The above-described mixed solution, after being transported in the third flow passage in not less than 0.001 sec. after the time of collision and mixing, is ejected from the back end of the flow passage to be stored in ripening/growth vessel 2.

One of the structure of the invention is characterized in that a mixed solution after collision is transported at a flow rate faster than that of each solution before mixing; it may be ejected at the flow rate into above-described ripening/growth vessel 2, or may be once stored in a separate vessel and, thereafter, transported to ripening/growth vessel 2.

In ripening/growth vessel 2, a gelatin solution having an excellent protective colloid property may be, or may not be dissolved while being heated. Nuclei of phosphor precursor particles introduced to ripening/growth vessel 2 may be, or may not be subjected to a ripening process.

Further, to phosphor precursor particles introduced in ripening/growth vessel 2, a furthermore raw material of a phosphor may be, or may not be added through nozzles 22 and 23.

The above embodiment is only an example, and the invention is not limited thereto.

Next, in what follows, such as the surrounding techniques including modified examples will be described.

In the above-described manufacturing example, an example was provided with each one flow passage for each raw material solution of a phosphor, however, in the invention, plural passages are preferably provided respectively in respect to achieving effects of the invention, and degree of freedom is wide such as a diameter of a flow passage being set wide.

Further, an example having no dynamic stirring function at crossing point C was shown, however, a dynamic stirring function such as a stirring fan may be provided.

Further, plural raw material solutions of a phosphor may be utilized and not less than three kinds of solutions may be mixed for the purpose of simultaneous mixing of such as a growth retarder and a coagulation retarder.

Further, a viscosity of a solution may sometimes rapidly increase at the moment of generation of phosphor precursor particles after collision and mixing of raw material solutions of a phosphor at crossing point C, which results in that, when a flow rate of a solution after mixing becomes slower than that of solutions in each flow passage before mixing, phosphor precursor particles are liable to adhere onto a wall forming a flow passage and irregular nucleation is liable to occur because of an inconstant flowing state of a solution.

Therefore, a flow rate of a solution after mixing in a flow passage is preferably not less than 1.2 times of each flow rate of each solution before mixing, more preferably not less than 2.0 times and most preferably not less than 3.0 times. A flow rate refers to a mean flow rate in a flow passage.

The above-described solution transporting time (time of staying while being transported in a manufacturing apparatus) is preferably not shorter than 0.001 sec., more preferably not shorter than 0.01 sec. and most preferably not shorter than 0.1 sec.

When the above-described each raw material solution of a phosphor is supplied into the first and second flow passages, it is practically preferably in a state of a turbulent flow to prevent a reverse flow in the neighborhood of a crossing point or to perform more homogeneous mixing of both solutions.

A turbulent flow is defined by a Reynolds number (Re). A Reynolds number is a dimensionless number obtained by the following equation, wherein a typical length of an object being present in a flow is D, a velocity is U, a density is ρ, and a coefficient of viscosity is η:

Re=ρDU/η

Generally, a state of Re<2300 is called as a laminar flow, a state of 2300<Re<3000 is called as a transition region and a state of Re≧3000 is called as a turbulent flow. Practically, a turbulent flow indicates a state of Re being nearly equal to 3000, preferably 5000<Re<100,000,000,000 and more preferably 10,000<Re<100,000,000.

Further, a mean particle size according to the invention is preferably not more than 0.1 μm and more preferably not more than 0.05 μm.

A mean particle size can be determined by placing fine particles contained in a phosphor directly on a mesh and observing arbitrarily not less than 1000 particles through a transmission-type electron microscope.

A preserver such as gelatin and a water-soluble polymer and a surfactant can be added in a part of or all of raw material solutions of a phosphor.

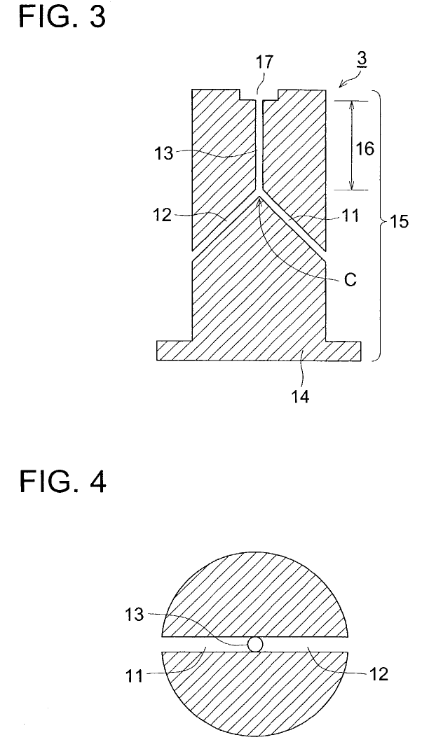

FIG. 3 shows another example of a manufacturing apparatus made of a high solvent resistant resin, by a center cross sectional drawing for convenience.

The parts which have the same functions as those in FIG. 1 are indicated by the same numbers.

The manufacturing apparatus of FIG. 1 has a constitution in which a mixed solution is transported from up to down, however, in the constitution of FIG. 3, a mixed solution is blown out from down to up.

The constitution, in which each one end of first flow passage 11, second flow passage 12 and third flow passage 13 is concentrated to form crossing point C, is same as that of FIG. 1.

However, in the examples, they are represented only by symbols 11, 12 and 13. A ripening/growth vessel is also similar to ripening/growth vessel 2 in FIG. 1.

The above-described three flow passages are formed by hollowing out a cylindrical material, and the size of the whole apparatus is as follows: a diameter at brim 14 is approximately 50 mm, a diameter of a cylinder portion provided with flow passages is approximately 40 mm and a height is approximately 100 mm.

Further, a diameter of the first flow passage, the second flow passage and the third flow passage (a cross section is a circle, similar to the case of FIG. 1) is 1.0 mm, and length 16 of third flow passage 13 (a distance from the place, where a wall forming the first flow passage and the second flow passage and a wall forming the third flow passage meet, to outlet 17) is 12.0 mm.

In the above-described apparatus, generation of particle nuclei of a phosphor precursor is such as what is described above, and because the constitutions such as a tank and a pump for solution transportation being provided are same as what is explained in reference to FIG. 1, the explanation is omitted here.

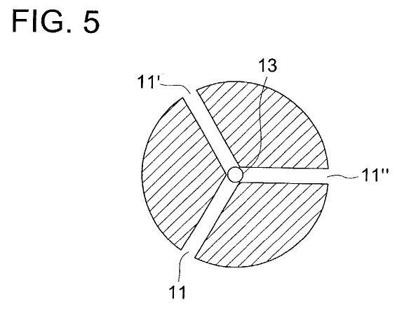

FIG. 4 is a conceptual drawing showing an example of a flow passage presenting a T-type, and FIG. 5 is a conceptual drawing showing an example of a flow passage presenting a Y-type.

### EXAMPLES

In what follows, the invention will be explained concretely according to examples, however, embodiments of the invention is not limited thereto.

Phosphor 1

(Comparative Example: Solid Phase Method, (Y,Gd)BO₃:Eu)

As for a red light emitting phosphor, yttrium oxide (Y₂O₃), gadolinium oxide (Gd₂O₃) and boric acid (H₃BO₃) as raw materials of a phosphor were blended so as to make a mole ratio of 0.315/0.185/1.00. Next, a prescribed amount of europium oxide (Eu₂O₃) is added to the mixture, being mixed with a suitable amount of flux by use of a ball mill, and the resulting system was burned under an oxidation condition of 1,400° C. for 2 hours to obtain phosphor 1.

Phosphor 2

(Comparative Example: Continuous Mixing, Laminar Flow, (Y, Gd) BO₃: Eu)

Yttrium nitrate hexahydrate, gadolinium nitrate and europium nitrate hexahydrate were dissolved in 500 ml of water, so as to make an ion concentration of yttrium of 0.4659 mol/l, an ion concentration of gadolinium of 0.2716 mol/l and an ion concentration of europium of 0.0388 mol/l, to prepare solution A. Boric acid was dissolved in 500 ml of water so as to make an ion concentration of boron of 0.7763 mol/l, to prepare solution B.

While both solutions were kept at a temperature of 40 ° C., solution A was supplied to 11 of the mixing apparatus of FIG. 3 (a tube diameter of 11 and 12 was 1 mm, a tube diameter of 13 was 1.42 mm) and solution B was supplied to 12 to perform mixing and reaction. An addition rate of both solutions was 30 ml/min, a line speed of the solution at 11 and 12 at that time was 0.637 m/s, and a Re number was 637; a line speed of the solution at 13 was 0.631 m/s and a Re number was 897.

The solution after addition was introduced to 2 of FIG. 1 and was ripened for 10 minutes to prepare precursor 2. Thereafter, precursor 2 was filtering dried to prepare dried precursor 2. Further, dried precursor 2 was burned under an oxidation condition of 1,400° C. for 2 hours to obtain phosphor 2.

Phosphor 3

(The invention: continuous mixing, turbulent flow, same speed after and before, (Y,Gd)BO₃:Eu)

Yttrium nitrate hexahydrate, gadolinium nitrate and europium nitrate hexahydrate were dissolved in 500 ml of water, so as to make an ion concentration of yttrium of 0.4659 mol/l, an ion concentration of gadolinium of 0.2716 mol/l and an ion concentration of europium of 0.0388 mol/l, to prepare solution A. Boric acid was dissolved in 500 ml of water, so as to make an ion concentration of boron of 0.7763 mol/l, to prepare solution B.

While both solutions were kept at a temperature of 40 ° C., solution A was supplied to 11 of the mixing apparatus of FIG. 3 (a tube diameter of 11 and 12 was 1 mm, a tube diameter of 13 was 1.42 mm) and solution B was supplied to 12 to perform mixing and reaction. An addition rate of both solutions was 150 ml/min, a line speed of the solution at 11 and 12 at that time was 3.18 m/s, and a Re number was 3,183; a line speed of the solution at 13 was 3.16 m/s and a Re number was 4,483.

The solution after addition was introduced to 2 of FIG. 1 and was ripened for 10 minutes to prepare precursor 3. Thereafter, precursor 3 was filtering dried to prepare dried precursor 3. Further, dried precursor 3 was burned under an oxidation condition of 1,400° C. for 2 hours to obtain phosphor 3.

Phosphor 4

(The invention: continuous mixing, turbulent flow, accelerated speed, (Y,Gd)BO₃:Eu)

Yttrium nitrate hexahydrate, gadolinium nitrate and europium nitrate hexahydrate were dissolved in 500 ml of water, so as to make an ion concentration of yttrium of 0.4659 mol/l, an ion concentration of gadolinium of 0.2716 mol/l and an ion concentration of europium of 0.0388 mol/l, to prepare solution A. Boric acid was dissolved in 500 ml of water, so as to make an ion concentration of boron of 0.7763 mol/l, to prepare solution B.

While both solutions were kept at a temperature of 40 ° C., solution A was supplied to 11 of the mixing apparatus of FIG. 3 (a tube diameter of 11 and 12 was 1 mm, a tube diameter of 13 was 1.42 mm) and solution B was supplied to 12 to perform mixing and reaction. An addition rate of both solutions was 150 ml/min, a line speed of the solution at 11 and 12 at that time was 3.18 m/s, and a Re number was 3,183; a line speed of the solution at 13 was 6.37 m/s and a Re number was 6,366.

The solution after addition was introduced to 2 of FIG. 1 and was ripened for 10 minutes to prepare precursor 4. Thereafter, precursor 4 was filtering dried to prepare dried precursor 4. Further, dried precursor 4 was burned under an oxidation condition of 1,400° C. for 2 hours to obtain phosphor 4.

Phosphor 5

(Comparative example: solid phase method, Zn₂SiO₄:Mn)

As for of a green light emitting phosphor, zinc oxide (ZnO) and silicon oxide (SiO₂) as raw materials of a phosphor were blended at a ratio of 2/1. Next, a prescribed amount of manganese oxide (Mn₂O₃) was added to the mixture, and the mixed system, after being mixed by a ball mill, was burned under a nitrogen atmosphere at 1,000° C. for 2 hours to obtain phosphor 5.

Phosphor 6

(Comparative example: continuous mixing, laminar flow, Zn₂SiO₄:Mn)

Sodium metasilicate was dissolved in 500 ml of water so as to make an ion concentration of silicon of 0.5000 mol/l to prepare solution A. Zinc chloride was dissolved in 500 ml of water so as to make an ion concentration of zinc of 0.9500 mol/l to prepare solution B. Manganese chloride tetrahydrate was dissolved in 500 ml of water so as to make an ion concentration of manganese of 0.0500 mol/l to prepare solution C.

While three solutions were all kept at a temperature of 60° C., mixing and reaction were performed by use of a mixing apparatus having a similar structure to FIG. 3 and provided with three feeding-side tubes as shown in FIG. 5. Solution A was supplied to flow passage 11, solution B to flow passage 11′ and solution C to flow passage 11″ to perform mixing and reaction (wherein, a tube diameter of 11, 11′ and 11″ was 1 mm and a tube diameter of 13 was 1.8 mm). An addition rate of three solutions was 30 ml/min, a line speed of a solution was 0.637 m/s and a Re number was 637 at 11, 11′ and 11″ at that time; a line speed of a solution was 0.589 m/s and a Re number was 1,061 at 13.

The solution after addition was introduced to 2 of FIG. 1 and was ripened for 10 minutes to prepare precursor 6. Thereafter, precursor 6 was filtering dried to prepare dried precursor 6. Further, dried precursor 6 was burned under a condition of a nitrogen atmosphere at 1,000° C. for 2 hours to obtain phosphor 6.

Phosphor 7

(The invention: continuous mixing, turbulent flow, same speed before and after, Zn₂SiO₄:Mn)

Sodium metasilicate was dissolved in 500 ml of water so as to make an ion concentration of silicon of 0.5000 mol/l to prepare solution A. Zinc chloride was dissolved in 500 ml of water so as to make an ion concentration of zinc of 0.9500 mol/l to prepare solution B. Manganese chloride tetrahydrate was dissolved in 500 ml of water so as to make an ion concentration of manganese of 0.0500 mol/l to prepare solution C.

While three solutions were all kept at a temperature of 60° C., mixing and reaction were performed by use of a mixing apparatus having a similar structure to FIG. 3 and provided with three feeding-side tubes as shown in FIG. 5. Solution A was supplied to flow passage 11, solution B to flow passage 11′ and solution C to flow passage 11″ to perform mixing and reaction (wherein, a tube diameter of 11, 11′ and 11″ was 1 mm and a tube diameter of 13 was 1.8 mm). An addition rate of three solutions was 150 ml/min, a line speed of a solution was 3.18 m/s and a Re number was 3,183 at 11, 11′ and 11″ at that time; a line speed of a solution was 2.95 m/s and a Re number was 5,305 at 13. The solution after addition was introduced to 2 of FIG. 1 and was ripened for 10 minutes to prepare precursor 7. Thereafter, precursor 7 was filtering dried to prepare dried precursor 7. Further, dried precursor 7 was burned under a condition of a nitrogen atmosphere at 1,000° C. for 2 hours to obtain phosphor 7.

Phosphor 8

(The invention: continuous mixing, turbulent flow, accelerated speed, Zn₂SiO₄:Mn)

Sodium metasilicate was dissolved in 500 ml of water so as to make an ion concentration of silicon of 0.5000 mol/l to prepare solution A. Zinc chloride was dissolved in 500 ml of water so as to make an ion concentration of zinc of 0.9500 mol/l to prepare solution B. Manganese chloride tetrahydrate was dissolved in 500 ml of water so as to make an ion concentration of manganese of 0.0500 mol/l to prepare solution C.

While three solutions were all kept at a temperature of 60° C., mixing and reaction were performed by use of a mixing apparatus having a similar structure to FIG. 3 and provided with three feeding-side tubes as shown in FIG. 5. Solution A was supplied to flow passage 11, solution B to flow passage 11′ and solution C to flow passage 11″ to perform mixing and reaction (wherein, a tube diameter of 11, 11′ and 11″ was 1 mm and a tube diameter of 13 was 1 mm). An addition rate of three solutions was 150 ml/min, a line speed of a solution was 3.18 m/s and a Re number was 3,183 at 11, 11′ and 11″ at that time; a line speed of a solution was 9.55 m/s and a Re number was 9,549 at 13. The solution after addition was introduced to 2 of FIG. 1 and was ripened for 10 minutes to prepare precursor 8. Thereafter, precursor 8 was filtering dried to prepare dried precursor 8. Further, dried precursor 8 was burned under a condition of a nitrogen atmosphere at 1,000° C. for 2 hours to obtain phosphor 8. Herein, an electric conductivity of the precursor was 45.0 mS/cm.

Phosphor 9

(The invention: continuous mixing, turbulent flow, accelerated speed, Zn₂SiO₄:Mn)

Sodium metasilicate was dissolved in 500 ml of water so as to make an ion concentration of silicon of 0.5000 mol/l to prepare solution A. Zinc chloride was dissolved in 500 ml of water so as to make an ion concentration of zinc of 0.9500 mol/l to prepare solution B. Manganese chloride tetrahydrate was dissolved in 500 ml of water so as to make an ion concentration of manganese of 0.0500 mol/l to prepare solution C.

While three solutions were all kept at a temperature of 60° C., mixing and reaction were performed by use of a mixing apparatus having a similar structure to FIG. 3 and provided with three feeding-side tubes as shown in FIG. 5. Solution A was supplied to flow passage 11, solution B to flow passage 11′ and solution C to flow passage 11″ to perform mixing and reaction (wherein, a tube diameter of 11, 11′ and 11″ was 1 mm and a tube diameter of 13 was 1 mm). An addition rate of three solutions was 150 ml/min, a line speed of a solution was 3.18 m/s and a Re number was 3,183 at 11, 11′ and 11″ at that time; a line speed of a solution was 9.55 m/s and a Re number was 9,549 at 13. The solution after addition was introduced to 2 of FIG. 1 and was ripened for 10 minutes and further was desalted by use of an ultrafiltration apparatus to prepare precursor 9 having an electric conductivity of 17.8 mS/cm. Thereafter, precursor 9 was filtering dried to prepare dried precursor 9. Further, dried precursor 9 was burned under a condition of a nitrogen atmosphere at 1,000° C. for 2 hours to obtain phosphor 9.

The following measurements were performed with each phosphor.

An emission at a 147 nm excitation was measured by use of phosphor spectrometer produced by Otsuka Denshi Co., Ltd., and represented by a relative emission strength of a phosphor when an emission strength of comparative phosphor was set to 100%. A comparison for phosphors 1 to 4 and that for phosphor 5 to 9 was phosphor 5.

Further, a particle diameter of a phosphor was measured by observing a phosphor particle and by measuring a particle diameter of 500 particles through a transmission-type electron microscope, and was represented by a mean particle diameter.

A coefficient of variation was determined by the equation described in the detailed explanation.

TABLE 1

| | | Mean | Coefficient | Relative |
|---|---|---|---|---|
| | | particle | of | emission |
| | State of | diameter | variation | strength |
| | flow | (μm) | (%) | (%) |
| Phosphor 1 | — | 2.1 | 323 | 100 |
| (Comparison) | | | | |
| Phosphor 2 | Laminar | 2.7 | 287 | 104 |
| (Comparison) | flow | | | |
| Phosphor 3 | Turbulent | 0.3 | 53 | 138 |
| (Invention) | flow | | | |
| Phosphor 4 | Turbulent | 0.2 | 38 | 139 |
| (Invention) | flow | | | |
| Phosphor 5 | — | 3.2 | 259 | 100 |
| (Comparison) | | | | |
| Phosphor 6 | Laminar | 4.0 | 270 | 102 |
| (Comparison) | flow | | | |
| Phosphor 7 | Turbulent | 0.5 | 37 | 169 |
| (Invention) | flow | | | |
| Phosphor 8 | Turbulent | 0.4 | 24 | 176 |
| (Invention) | flow | | | |
| Phosphor 9 | Turbulent | 0.4 | 22 | 190 |
| (Invention) | flow | | | |

As shown above, it has been proved that a phosphor having excellent characteristics can be obtained by utilizing a manufacturing apparatus for a phosphor precursor and a manufacturing method for a phosphor precursor, of the invention.

Further, a phosphor of the invention has been proved to be excellent in that relative emission strength never decreases even when a mean particle diameter of a phosphor becomes small.

A manufacturing apparatus of a phosphor precursor and a manufacturing method of a phosphor precursor, according to the invention, are provided with an excellent effects to control a particles and to obtain a crystal habit of phosphor precursor particles and to obtain a phosphor having a small particle diameter as well as a high luminance.

What is claimed is:

1. A method for manufacturing a phosphor precursor by using a mixing device comprising:
(a) at least one first inlet flow passage;
(b) at least one second inlet flow passage, the first inlet flow passage and the second inlet flow passage connect together so as to form a collision section; and
(c) an outlet flow passage which is connected with the collision section,
the method comprising the steps of:
(i) supplying continuously a first raw phosphor material solution into the first inlet flow passage and a second raw phosphor material solution into the second inlet flow passage;
(ii) introducing the first raw phosphor material solution and the second raw phosphor material solution into the collision section so as to mix with each other and to form a phosphor precursor; and
(iii) releasing continuously the phosphor precursor from an exit of the outlet flow passage with controlling a flow of the phosphor precursor so as to keep a Reynolds number of the phosphor precursor to be not less than 3000 while retaining the phosphor precursor in the outlet flow passage for not less than 0.001 seconds.

2. A method for manufacturing a phosphor precursor by using a mixing device comprising:
(a) a first inlet flow passage;
(b) a second inlet flow passage, the first inlet flow passage and the second inlet flow passage connect together so as to form a collision section; and
(c) an outlet flow passage which is connected with the collision section,
the method comprising the steps of:
(i) supplying continuously a first raw phosphor material solution into the first inlet flow passage and a second raw phosphor material solution into the second inlet flow passage;
(ii) introducing the first raw phosphor material solution and the second raw phosphor material solution into the collision section so as to mix with each other and to form a phosphor precursor; and
(iii) releasing continuously the phosphor precursor from an exit of the outlet flow passage,
wherein in the step (iii), the flow rate of the phosphor precursor is larger than a flow rate of the first raw phosphor material solution and a flow rate of the second raw phosphor material solution.

3. The method for manufacturing a phosphor precursor of claim 2, wherein in the step (iii), a retention time of the phosphor precursor in the outlet flow passage is not less than 0.001 seconds.

4. The method for manufacturing a phosphor precursor of claim 1, wherein the mixing device comprises a plurality of the first inlet flow passages or a plurality of the second inlet flow passages.

5. The method for manufacturing a phosphor precursor of claim 2, wherein the mixing device comprises a plurality of the first inlet flow passages or a plurality of the second inlet flow passages.

6. The method for manufacturing a phosphor precursor of claim 1, wherein the method comprises further a step of:
desalting the phosphor precursor after being released form the exit of the outlet flow passage.

7. The method for manufacturing a phosphor precursor of claim 2, wherein the method comprises further a step of:
desalting the phosphor precursor after being released form the exit of the outlet flow passage.

8. The method for manufacturing a phosphor precursor of claim 6, wherein the desalted phosphor precursor has an electric conductivity of 0.0001 to 20 mS/cm.

9. The method for manufacturing a phosphor precursor of claim 7, wherein the desalted phosphor precursor has an electric conductivity of 0.0001 to 20 mS/cm.
